(19) United States
(12) Patent Application Publication
(10) Pub. No.: US 2008/0212922 A1
(43) Pub. Date: Sep. 4, 2008

(54) Switchable Optical Element

(75) Inventors: Stein Kuiper, Eindhoven (NL); Bernardus Hendrikus Wilhelmus Hendriks, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/916,820

(22) PCT Filed: Jun. 7, 2006
(86) PCT No.: PCT/IB06/51811

§ 371 Date: Dec. 7, 2007

(30) Foreign Application Priority Data
Jun. 10, 2005 (EP) 05105102.7

(51) Int. Cl. G02B 6/26

(52) U.S. Cl. 385/16

(57) ABSTRACT

A switchable optical element has an optical axis. The element includes a chamber, a wave front modifier having a face defining an interior surface of the chamber (the face extending transverse the optical axis), a first fluid and a second fluid. The fluids are immiscible and in contact over an interface. The optical element is switchable between a first discrete state in which the first fluid substantially covers the face of the wave front modifier, and a second discrete state in which the second fluid substantially covers the face of the wave front modifier, wherein the chamber encloses both fluids in both discrete states, and the interlace extends transverse the optical axis in the first discrete state.

The present invention relates to a switchable optical element, to devices including switchable optical elements, and to methods of manufacture and operation of such devices and elements. Embodiments of the element are particularly suitable for use in an optical scanning device for scanning the information layers of different types of optical record carrier.

Optical record carriers exist in a variety of different formats, with each format generally being designed to be scanned by a radiation beam of a particular wavelength. For example, CDs are available, inter alia, as CD-A (CD-audio), CD-ROM (CD-read only memory) and CD-R (CD-recordable), and are designed to be scanned by means of a radiation beam having a wavelength (λ) of around 785 nm. DVDs, on the other hand, are designed to be scanned by means of a radiation beam having a wavelength of about 650 nm, and BDs are designed to be scanned by means of a radiation beam having a wavelength of about 405 nm. Generally, the shorter the wavelength, the greater the corresponding capacity of the optical disc e.g. a BD-format disc has a greater storage capacity than a DVD-format disc.

It is desirable for an optical scanning device to be compatible with different formats of optical record carriers, e.g. for scanning optical record carriers of different formats responding to radiation beams having different wavelengths whilst preferably using one objective lens system. For instance, when a new optical record carrier with higher storage capacity is introduced, it is desirable for the corresponding new optical scanning device used to read and/or write information to the new optical record carrier to be backward compatible i.e. to be able to scan optical record carriers having existing formats.

In order to allow the optical properties of optical scanning devices to be adjusted for different formats of optical record carriers, a variety of variable or switchable optical elements are known. Switchable optical elements are optical elements that can be switched between two or more different states, with the optical element having different optical properties within each state.

For instance, U.S. Pat. No. 6,288,846 describes systems in which a fluid system can be switched between two different discrete states in order to provide different wave front modifications. A refractive index difference of approximately zero is established between a fluid and a wave front modifier, when the system is in one of these states, in order to leave the radiation beam unchanged. In the other state of the system, this refractive index difference is of sufficient value such that the path of the radiation beam is modified. A fluid-handling system is used to switch the fluid system between states. Examples of the fluid handling system include hypodermic syringes, peristaltic pumps, compressible bulbs, and piezoelectric, hydraulic or pneumatic actuators.

WO2004/027490 to Philips Electronics describes an improved switchable optical element having a first discrete state and a second, different discrete state. The element comprises a fluid system including a first fluid and a different, second fluid, a wave front modifier having a face, and a fluid system switch for acting on the fluid system to switch between the first and second discrete states of the element. The wave front modifier is located within a chamber. A conduit extends between opposite sides of the chamber. When the element is in the first discrete state, the face of the wave front modifier is substantially covered by the first fluid, with the second fluid being located in the conduit. When the element is in the second discrete state, the face of the wave front modifier is substantially covered by the second fluid, with the first fluid being located in the conduit. The fluid system switch utilizes the electro wetting effect to move the fluids between the chamber (and covering the wave front modifier), and the conduit.

Such known systems can be complex to manufacture, with the relevant pumps, syringes or channels increasing both the overall size and the complexity of the optical element.

It is an aim of embodiments of the present invention to provide a switchable optical element that addresses one or more problems of the prior art, whether described herein or otherwise. It is an aim of particular embodiments of the present invention to provide a switchable optical element that is easier to manufacture.

According to a first aspect of the present invention, there is provided a switchable optical element having an optical axis, the element comprising a chamber; a wave front modifier having a face defining an interior surface of the chamber, the face extending transverse the optical axis; a first fluid and a second fluid, the fluids being immiscible and being in contact over an interface; the optical element being switchable between a first discrete state in which the first fluid substantially covers the face of the wave front modifier, and a second discrete state in which the second fluid substantially covers the face of the wave front modifier; wherein the chamber encloses both fluids in both discrete states, and the interface extends transverse the optical axis in the first discrete state.

As such an optical element maintains both the fluids within a single chamber whilst switching between states, the structure of the device is less complex than prior art devices that require additional conduits or separate mechanical pumps. Thus, the structure of such an optical element is easier to manufacturer, and may be made relatively compact i.e. thus reducing the footprint (area occupied) by the element in any device or apparatus.

The optical element may further comprise a fluid switching system arranged to switch the optical element between the first and second discrete states by moving the fluids utilizing the electro wetting effect.

The fluid switching system may comprise a first electrode coupled to the second fluid, and a second electrode located adjacent the face of the wave front modifier.

The face of the wave front modifier may comprise a first contact layer forming an insulating barrier between the second electrode and the fluids within the chamber.

The second electrode may extend adjacent the face of the wave front modifier, a fixed predetermined distance from the face of the wave front modifier.

The second electrode may comprise a plurality of independently addressable sections.

The face of the wave front modifier may be non-planar.

The face of the wave front modifier may define at least one protrusion.

The at least one protrusion may be less than 50 μm in height.

The at least one protrusion may form a diffraction grating.

The chamber may comprise at least one sidewall to which the interface extends in the first discrete state.

The wettability of said sidewall may be such that the interface extends in a plane transverse the optical axis when in the first discrete state.

The wettability of said sidewall may be such that the interface is curved when in the first discrete state.

The optical element may further comprise an interface electrode located adjacent said at least one sidewall for controlling the wettability of said wall.

According to a second aspect of the present invention, there is provided an apparatus comprising a switchable optical element as described above.

The apparatus may be an optical scanning device.

According to a third aspect of the present invention, there is provided a method of operating an apparatus comprising: a switchable optical element having an optical axis, the element comprising a chamber; a wave front modifier having a face defining an interior surface of the chamber, the face extending transverse the optical axis; a first fluid and a second fluid, the fluids being immiscible and being in contact over an interface; the optical element being switchable between a first discrete state in which the first fluid substantially covers the face of the wave front modifier, and a second discrete state in which the second fluid substantially covers the face of the wave front modifier; wherein the chamber encloses both fluids in both discrete states, and the interface extends transverse the optical axis in the first discrete state, the method comprising: switching the optical element between the first discrete state and the second discrete state.

The apparatus may further comprise a radiation source arranged to provide a first beam of radiation in a first mode of operation, and a second beam of radiation in a second mode of operation, the method comprising: switching the optical element between the discrete states in dependence upon a signal indicative of the mode of operation of the radiation source.

According to a fourth aspect of the present invention, there is provided a method of manufacturing a switchable optical element having an optical axis, the method comprising providing a chamber; providing a wave front modifier having a face defining an interior surface of the chamber, the face extending transverse the optical axis; providing a first fluid and a second fluid, the fluids being immiscible and being in contact over an interface; providing a fluid switching system for switching the optical element between a first discrete state in which the first fluid substantially covers the face of the wave front modifier, and a second discrete state in which the second fluid substantially covers the face of the wave front modifier; wherein the chamber encloses both fluids in both discrete states, and the interface extends transverse the optical axis in the first discrete state.

Preferred embodiments of the present invention will now be described, by way of example only, with reference to the accompanying drawings, in which:

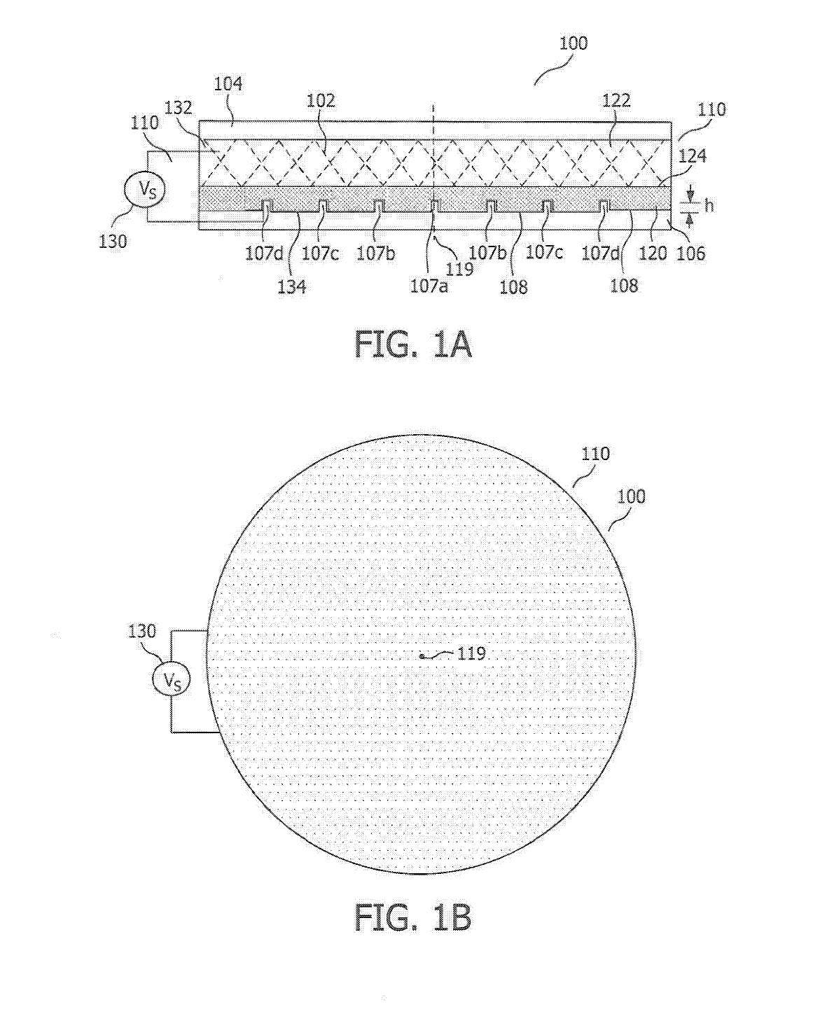

FIGS. 1A and 1B show respectively a side cross-sectional view and a plan view of a switchable optical element in accordance with a first embodiment, in a first discrete state;

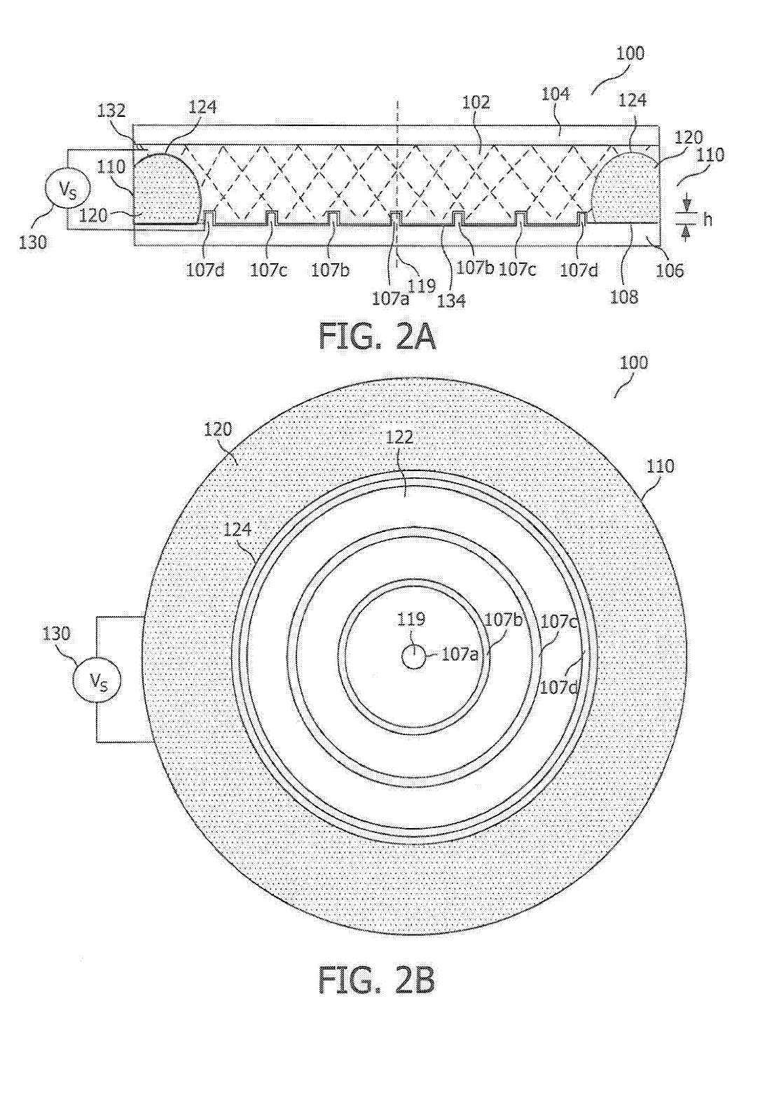

FIGS. 2A and 2B show respectively a side cross-sectional view and a plan view of the optical element of the first embodiment, in a second discrete state;

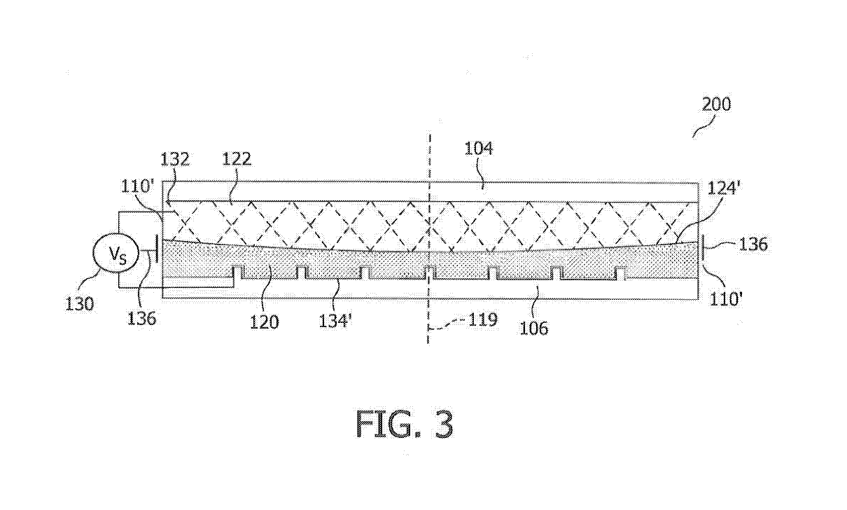

FIG. 3 shows a side cross-sectional view of an optical element in accordance with a second embodiment, in a first discrete state; and

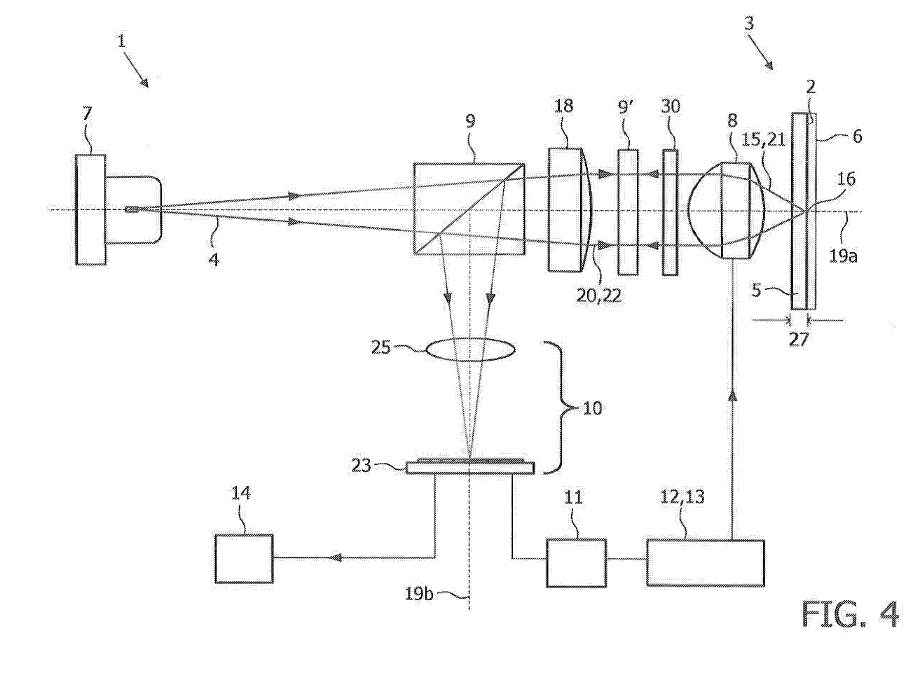

FIG. 4 shows a schematic diagram of an optical scanning device incorporating a switchable optical element in accordance with an embodiment of the present invention.

FIGS. 1A-2B show a switchable optical element 100 in accordance with a first embodiment of the present invention. FIGS. 1A and 1B show the element 100 in a first discrete state, with FIGS. 2A and 2B showing the element in the second discrete state.

The switchable element 100 includes a chamber 102, with an optical axis 119 extending through the chamber. The chamber 102 has end walls 104, 106 extending transverse the optical axis 119. In this particular embodiment, the end walls 104, 106 extend generally perpendicular to the optical axis 119. The element 100 is arranged to control a beam of radiation incident along the optical axis 119. End walls 104, 106 are thus formed of a rigid material that is transparent e.g. glass.

In this particular embodiment, the chamber is cylindrical. The chamber is circularly symmetric about optical axis 119. The sides of the chamber are thus defined by a single continuous sidewall 110 extending parallel to optical axis 119.

The element 100 includes a wave front modifier having a face defining an interior surface of the chamber. The wave front modifier is arranged to modify the wave front of an incident radiation beam, when the optical element is in at least one of the discrete states. The face of the wave front modifier is non-planar. The face may be curved, for providing an optical power (e.g. to function as a lens). In this particular embodiment, the face comprises a number of protrusions (107a-107d). The protrusions form a series of steps of predetermined height. In this particular embodiment, each step is of equal predetermined height h, and circularly symmetric about optical axis 119. Central step 107a is cylindrical. Steps 107b-107d are annular steps, coaxial with optical axis 119. The optical element is arranged to control a beam of radiation transmitted through the optically active portion of the optical element. The face of the wave front modifier extends across the optically active portion of the optical element 100.

The chamber 102 encloses two fluids 120, 122. The two fluids are immiscible, and have at least one different optical property. For instance, refractive indices, the color, absorption, reflectivity or optical opacity of the fluids may differ. Preferably, the fluids 120, 122 are of equal density, such that operation of the device is not unduly influenced by mechanical affects or gravity. In this particular embodiment, each fluid has a different refractive index. The fluids are in contact over an interface 124.

The switchable optical element 100 is switchable between two discrete states. In the first discrete state (shown in FIGS. 1A and 1B) the first fluid 120 covers the face of the wave front modifier (defined by projections 107a-107d in this embodiment). Both bodies of fluid 120, 122 extend transverse the optical axis 119. The interface 124 between the first and second fluids 120, 122 extends transverse the optical axis. The periphery of the interface 124 contacts side wall 110. The sidewall 110 has an equal wettability with respect to both fluids 120, 122 (at least at the position at which the interface 124 intersects the sidewall 110). Thus, the three-phase contact angle (the angle between the two fluids and the side wall) extends perpendicular to the sidewall. The thickness of the first fluid over the face of the wave front modifier is such that the shape of the interface 124 is not affected by the shape of the face. Thus, the interface 124 is planar.

It should be appreciated, that in other embodiments, the sidewalls may not extend parallel to the optical axis 119. However, by appropriate selection of the wettability of the sidewall(s), so as to define the correct three-phase contact angle(s), the interface 124 between the two fluids can be formed as planar in the first discrete state.

FIGS. 2A and 2B show the switchable optical element in the second discrete state. In the second discrete state, the second fluid 122 covers the face of the wave front modifier. In the second discrete state, the first fluid 120 is located outside of the optically active portion of the chamber 102. The first fluid 120 does not extend through the optical axis 119. The first fluid 120 is disposed at the periphery of the chamber 102. In this particular embodiment, the first fluid 120, in the second discrete state of the element 100, extends in an annulus, coaxial with the optical axis 119. The first fluid 120 covers a surface of the end wall 106 adjacent, but outside, the face of the wave front modifier. As the second fluid 120 has different optical properties (in this embodiment, a different refractive index) than the first fluid, the operation of the face of the wave front modifier will be different when the optical element 100 is in the second discrete state to that in the first discrete state. Preferably, the refractive index of one of said fluids is equal to the refractive index of the material(s) defining the face of the wave front modifier. In such an instance, the optical function provided by the wave front modifier is negated i.e. the wave front modifier effectively becomes invisible to incident radiation (or at least incident radiation at the wavelength at which the refractive indices are the same).

The element 100 is switchable between the first discrete state (FIGS. 1A, 1B) and the second discrete state (FIGS. 2A, 2B) utilizing the electro wetting effect. One of said fluids is an electrically susceptible fluid e.g. a polar or conductive fluid such as salted water. The other fluid will be an electrically unsusceptible fluid (i.e. a fluid that is not affected by the application of an electric field) e.g. an electrically insulative fluid such as silicone oil.

In the embodiments of the invention shown in the Figures, the first fluid 120 is oil, and the second fluid 122 is salted water.

A hydrophobic insulator defines a first cover layer 108, which extends across an inner surface of the chamber 102, at one end of the chamber. The cover layer 108 extends over the protrusions (107a-107d) formed by the glass 106. The cover layer 108 thus defines the face of the wave front modifier. Additionally, the cover layer 108 covers an area of the interior surface of the chamber 102 adjacent the face of the wave front modifier. In the particular example shown, the cover layer 108 is a continuous cover layer extending over all of the interior surface defined by end wall 106. The opposite inner surface of the chamber 102 (defined by end wall 104) is hydrophilic, so as to attract electrically susceptible fluids such as water e.g. the inner surface of the end wall 104 is formed of glass.

In the first discreet state, shown in FIGS. 1A and 1B, the second fluid 122 is preferentially attracted toward the end wall 104, due to the hydrophilic nature of the inner surface of that end wall. Equally, the first fluid 120 is preferentially attractive to the hydrophobic nature of the inner surface of the end wall 104, and thus covers the face of the wave front modifier.

The optical element 100 is switched to the second discrete state (FIGS. 2A and 2B) by utilizing the electro wetting effect to modify the wettability of the face of the wave front modifier, so as to attract the electrically susceptible second fluid 122 to cover that face. The first fluid 120 is displaced by the second fluid to then only cover the inner surface of end wall 106 in the area that remains hydrophobic i.e. the area, adjacent to the face of the wave front modifier. The first fluid 120 is thus displaced in the second discrete state to a position outside of the optically active area of the optical element.

The wettability of the face of the wave front modifier is controlled using a fluid switching system. The fluid switching system comprises a transparent electrode 134 located adjacent the face of the wave front modifier. Preferably, the electrode 134 extends adjacent the face of the wave front modifier, within a fixed predetermined distance from the face of the wave front modifier. Preferably, the electrode 134 extends parallel to the face of the wave front modifier. For instance, if the face of the wave front modifier defines protrusions, then the electrode 134 extends within the protrusions, a predetermined distance from the face of the wave front modifier. Preferably, the electrode 134 extends over a surface area equal to that of the face of the wave front modifier i.e. the electrode 134 underlies all of the surface area of the face of the wave front modifier.

Another electrode 132 is in electrical contact with the electrically susceptible fluid 122. By applying a voltage from the voltage source 130 between electrodes 132, 134, the wettability of the face of the wave front modifier can be altered. Thus, the switchable optical element 100 can be switched from the first discrete state to the second discrete state by applying an appropriate voltage so as to alter the wettability of the face of the wave front modifier. Equally, by removing the voltage, the wettability of the face will return to its nominal, hydrophobic nature, and the optical element will switch from the second discrete state back to the first discrete state.

It will be appreciated that the above embodiment is described by way of example only.

For instance, the face of the wave front modifier may be curved in any form, or define a non-periodic phase structure. The height of any protrusion (the height being the dimension of the protrusion along the optical axis of the optical element) may be any predetermined size, suitable for the particular application of the switchable optical element. Preferably, the height h of such protrusions is less than 50 μm, and more preferably the height is between 5 μm and 20 μm, but may be substantially equal to or less than 5 μm. These dimensions are preferable, as they facilitate the covering and uncovering of the face by the fluids. The term fluid encompasses any material that is capable of flow, including, but not limited to gases, vapours, liquids and liquid crystals.

The switchable optical element may be utilised in any apparatus. If the optical element is located within an apparatus in which two or more beams of radiation are utilised, the wave front modifier can be arranged to provide different modifications to the wave front of different beams of radiation, either due to the polarization of the incident radiation or the wavelength of the radiation.

For instance, the face of the wave front modifier can be formed of a birefringent material, such as liquid crystal. The principal axis of the liquid crystal is arranged in a direction transverse (e.g. perpendicular) the optical axis 119. The molecules of liquid crystal can thus be orientated such that a radiation beam of a first polarization will experience a different index of refraction of the wave front modifier than a radiation beam of a second, different polarization. Thus, different polarizations of incident radiation beams can experience different wave front modifications by the optical element.

Equally, if the surface of the wave front modifier defines a diffractive grating, then the steps of the grating can be of predetermined height, such that in at least one discrete state, the steps are arranged to introduce a phase change that is substantially an integral multiple of 2π to an incident beam of radiation of predetermined wavelength. Thus, a radiation beam of that particular wavelength, incident upon the wave front modifier, whilst the optical element is in that particular discrete state, will not be modified by the diffractive grating. However, radiation beam of other wavelengths incident upon the steps of the diffractive grating, whilst the wave front modifier is in that particular discrete state, will be diffracted by the diffractive grating formed by the wave front modifier.

The chamber in the above embodiment has been described as being cylindrical. However, it will be appreciated that the chamber may be formed in any predetermined shape e.g. cuboidal or otherwise. In all embodiments, the chamber encloses (i.e. contains wholly there within) the two bodies of fluid.

In relation to the embodiments shown in FIGS. 1A-2B, the interface 124 between the first fluid 120 and the second fluid 122 has been described as being planar in the first discrete mode of operation (FIGS. 1A and 1B). The interface 124 is flat, due to the sidewall 110 having equal wettability for the first fluid 120 as the second fluid 122. Thus, the interface 124 extends perpendicular to the sidewalls 110. However, the wettability of the sidewall 110 can be made greater for either of the fluids. This will change the angle of the interface or meniscus 124. As the interface 124 attempts to achieve the minimum possible energy configuration, then the interface 124 will be curved (when the optical element is in the first discrete state) if the sidewall surface is preferentially wetted by one of the fluids (assuming the sidewall or sidewalls extend parallel to the optical axis). Alternatively, the wettability of the sidewall may be dynamically controlled over a continuously predetermined range, using a modified fluid switching system.

FIG. 3 shows a switchable optical element 200 in a first discrete state. The optical element 200 corresponds generally to the optical element 100 shown in FIGS. 1A-2B. The second discrete state of optical element 200 is with the fluids 120, 122 in the same positions as illustrated in FIGS. 2A and 2B.

However, in the embodiment shown in FIG. 3, the wettability of the sidewall 110′ can be dynamically controlled. Varying the wettability of the sidewall 110′ alters the shape (i.e. degree of curvature) of the interface 124′ between the fluids 120, 122 to be altered. As the fluids 120, 122 have different refractive indices, then altering the curvature of the interface 124′ between concave, complex and flat, and/or the degree of curvature of the interface 124′, will alter the effective optical power provided by the interface to incident radiation. This provides an extra degree of functionality to the optical element 200.

For instance, the optical element 200 may be utilised in an apparatus utilizing three different beams of radiation. The optical element 200 will be controlled to be in one discrete state when the apparatus is utilizing either the first or second radiation beams, and in the other discrete state when the apparatus is utilizing the third radiation beam. The curvature of the interface 124′ can be varied, dependent upon the radiation beam utilised, to provide the required degree of focusing or defocusing of any radiation beam.

The wettability of the surface 110′ is adjusted by utilizing an additional electrode 136 located adjacent the interior surface of sidewall 110′. Electrode 136 extends parallel to the sidewall 110. In this embodiment, the electrode 136 is annular, coaxial with the optical axis 119. The electrode 136 is electrically insulated from the interior surface of the chamber (i.e. the fluids within the chamber). By applying a voltage between electrode 132 and electrode 136 from voltage source 130, the wettability of the internal surface of the chamber adjacent the electrode 136 can be altered. The wettability of the surface will be dependent upon the applied voltage.

Such a system allows the optical power of the interface 124′ to be adjusted.

In a further embodiment, the electrode 134 adjacent the face of the wave front modifier is formed of a plurality of independently addressable sections. In other words, different voltages may be applied to different sections of the electrode 134. Thus, the wettability of the different areas of the face of the wave front modifier can be independently altered. This can be utilised to facilitate switching between the different discrete modes of operation, by varying the applied voltages as a function of time on each of the addressable sections, to facilitate movement of the fluids. Equally, different voltages may be applied to different sections of the electrode 134, so as to selectively attract the portion of the second fluid 122 overlying the electrode section towards the electrode section (but the voltages being of predetermined value such that the first fluid 120 still covers the whole face of the wave front modifier). Thus, the shape of the interface 124, 124′ can be deformed using independently addressable sections of the electrode, to provide spherical aberration to incident beams (e.g. for spherical aberration compensation). The perimeter of the meniscus may be pinned to the wall by an abrupt change in wettability or geometry of the wall. Using such a configuration, the meniscus shape can be altered between convex, flat, and concave by appropriate control of the voltage(s) to electrode 134.

Switchable optical elements, as described herein, may be utilised within a variety of apparatus.

For example, FIG. 4 shows a device 1 for scanning a first information layer 2 of a first optical record carrier 3 by means of a first radiation beam 4, the device including an objective lens system 8.

The optical record carrier 3 comprises a transparent layer 5, on one side of which information layer 2 is arranged. The side of the information layer 2 facing away from the transparent layer 5 is protected from environmental influences by a protective layer 6. The side of the transparent layer facing the device is called the entrance face. The transparent layer 5 acts as a substrate for the optical record carrier 3 by providing mechanical support for the information layer 2. Alternatively, the transparent layer 5 may have the sole function of protecting the information layer, while the mechanical support is provided by a layer on the other side of the information layer 2, for instance by the protective layer 6 or by an additional information layer and transparent layer connected to the uppermost information layer. It is noted that the information layer has first information layer depth 27 that corresponds, in this embodiment as shown in FIG. 1, to the thickness of the transparent layer 5. The information layer 2 is a surface of the carrier 3.

Information is stored on the information layer 2 of the record carrier in the form of optically detectable marks arranged in substantially parallel, concentric or spiral tracks, not indicated in the figure. A track is a path that may be followed by the spot of a focused radiation beam. The marks may be in any optically readable form, e.g. in the form of pits, or areas with a reflection coefficient, or a direction of magnetization different from the surroundings, or a combination of these forms. In the case where the optical record carrier 3 has the shape of a disc.

As shown in FIG. 2, the optical scanning device 1 includes a radiation source 7, a collimator lens 18, a beam splitter 9, and an objective lens system 8 having an optical axis 19a, a switchable optical element 30, and a detection system 10. Furthermore, the optical scanning device 1 includes a servo circuit 11, a focus actuator 12, a radial actuator 13, and an information-processing unit 14 for error correction.

In this particular embodiment, the radiation source 7 is arranged for consecutively or separately supplying a first radiation beam 4, a second radiation beam 4′ and a third radiation beam 4″. For example, the radiation source 7 may comprise a tunable semiconductor laser for consecutively supplying two of the radiation beams 4, 4′ and 4″ with a separate laser supplying the third beam, or three semiconductor lasers for separately supplying these radiation beams.

The radiation beam 4 has a wavelength λ₁ and a polarization pᵢ, the radiation beam 4′ has a wavelength λ₂ and a polarization p₂, and the radiation beam 4″ has a wavelength λ₃ and a polarization p₃. The wavelengths λ₁, λ₂, and λ₃ are all different. Preferably, the difference between any two wavelengths is equal to, or higher than, 20 nm, and more preferably 50 nm. Two or more of the polarizations p₁, p₂, and p₃ may differ from each other.

The collimator lens 18 is arranged on the optical axis 19a for transforming the divergent radiation beam 4 into a substantially collimated beam 20. Similarly, it transforms the radiation beams 4′ and 4″ into two respective substantially collimated beams 20′ and 20″ (not shown in FIG. 4).

The beam splitter 9 is arranged for transmitting the radiation beams along an optical path towards the objective lens system 8. In the example shown, the radiation beams are transmitted towards the objective lens system 8 by transmission through the beam splitter 9. Preferably, the beam splitter 9 is formed with a plane parallel plate that is tilted at an angle α with respect to the optical axis, and more preferably α=45°. In this particular embodiment the optical axis 19a of the objective lens system 8 is common with an optical axis of the radiation source 7.

The objective lens system 8 is arranged for transforming the collimated radiation beam 20 to a first focused radiation beam 15 so as to form a first scanning spot 16 in the position of the information layer 2.

During scanning, the record carrier 3 rotates on a spindle (not shown in Figure), and the information layer 2 is then scanned through the transparent layer 5. The focused radiation beam 15 reflects on the information layer 2, thereby forming a reflected beam 21, which returns on the optical path of the forward converging beam 15. The objective lens system 8 transforms the reflected radiation beam 21 to a reflected collimated radiation beam 22.

The beam splitter 9 separates the forward radiation beam 20 from the reflected radiation beam 22 by transmitting at least part of the reflected radiation 22 along an optical path towards the detection system 10. In the illustrated example, the reflected radiation beam 22 is transmitted towards the detection system 10 by reflection from a plate within beam splitter 9. In the particular embodiment shown, the beam splitter 9 is a polarizing beam splitter. A quarter wave plate 9′ is positioned along the optical axis 19a between the beam splitter 9 and the objective lens system 8. The combination of the quarter wave plate 9′ and the polarizing beam splitter 9 ensures that the majority of the reflected radiation beam 22 is transmitted towards the detection system 10 along detection system optical axis 19b. The detection system optical axis 19b is a continuation of the optical axis 19a, due to the beam splitter 9 transmitting at least part of the reflected radiation 22 towards the detection system 10. Thus, the objective lens system optical axis comprises the axes indicated by reference numerals 19a and 19b.

The detection system 10 includes a convergent lens 25 and a detector 23, which are arranged for capturing said part of the reflected radiation beam 22.

The detector is arranged to convert said part of the reflected beam to one or more electrical signals.

One of the signals is an information signal, the value of which represents the information scanned on the information layer 2. The information signal is processed by the information-processing unit 14 for error correction.

Other signals from the detection system 10 are a focus error signal and a radial tracking error signal. The focus error signal represents the axial difference in height along the Z-axis between the scanning spot 16 and the position of the information layer 2. Preferably, this signal is formed by the “astigmatic method” which is known from, inter alia, the book by G. Bouwhuis, J. Braat, A. Huijiser et al, “Principles of Optical Disc Systems”, pp. 75-80 (Adam Hilger 1985, ISBN 0-85274-785-3). The radial tracking error signal represents the distance in the XY-plane of the information layer 2 between the scanning spot 16 and the center of track in the information layer 2 to be followed by the scanning spot 16. This signal can be formed from the “radial push-pull method” which is also known from the aforesaid book by G. Bouwhuis, pp. 70-73.

The servo circuit 11 is arranged for, in response to the focus and radial tracking error signals, providing servo control signals for controlling the focus actuator 12 and the radial actuator 13 respectively. The focus actuator 12 controls the position of the objective lens 8 along the Z-axis, thereby controlling the position of the scanning spot 16 such that it coincides substantially with the plane of the information layer 2. The radial actuator 13 controls the radial position of the scanning spot 16 so that it coincides substantially with the centerline of the track to be followed in the information layer 2 by altering the position of the objective lens 8.

The objective lens 8 is arranged for transforming the collimated radiation beam 20 to the focused radiation beam 15, having a first numerical aperture NA₁, so as to form the scanning spot 16. In other words, the optical scanning device 1 is capable of scanning the first information layer 2 by means of the radiation beam 15 having the wavelength λ₁, the polarization p₁ and the numerical aperture NA₁.

Furthermore, the optical scanning device in this embodiment is also capable of scanning a second information layer 2′ of a second optical record carrier 3′ by means of the radiation beam 4′, and a third information layer 2″ of a third optical record carrier 3″ by means of the radiation beam 4″. Thus, the objective lens system 8 transforms the collimated radiation beam 20′ to a second focused radiation beam 15′, having a second numerical aperture NA₂ so as to form a second scanning spot 16′ in the position of the information layer 2′. The objective lens 8 also transforms the collimated radiation beam 20″ to a third focused radiation beam 15″, having a third numerical aperture NA₃ so as to form a third scanning spot 16″ in the position of the information layer 2″.

Any one or more of the scanning spots 16, 16′, 16″ can be formed with two additional spots for use in providing an error signal. For example, a switchable optical element 30 in accordance with an embodiment of the present invention is located in the path of the optical beam 20. The switchable optical element is operated in the first discrete mode when the optical scanning device is scanning using the first and second radiation beam, and in the second discrete mode when the optical scanning devices scan using the third radiation beam. The face of the wave front modifier is arranged as a diffractive grating, so as to provide the two additional spots for use in providing an error signal. The two fluids of the diffractive element have different refractive indices. One of the fluids has the same refractive index as the material defining the diffractive grating of the face of the wave front modifier. In one of the discrete states, the wave front modifier will diffract the incident radiation beam to provide the two additional spots for use in providing an error signal. In the other discrete state, the switchable optical element does not diffract incident radiation, such that the two additional spots are not formed. Preferably, the shape of the meniscus of the optical element can be varied, as described above with reference to the embodiment shown in FIG. 3, so as to provide an optical power. This can be used to facilitate, for instance, dual layer readout for one of the radiation beams 15, 15′, 15″.

Another example of the use of the element 30 in an optical scanning device is to enable reading/writing of two or more different disc formats (e.g. in a single optical drive). Examples are discussed in WO2004/027490 and are incorporated herein by reference. The switchable optical element is utilized to modify the wave front of the radiation beam, so as to allow compatibility of the optical scanning device for reading different formats of optical record carrier. The wave front modification is specific to the type of record carrier being scanned.

Similarly to the optical record carrier 3, the optical record carrier 3′ includes a second transparent layer 5′ on one side of which the information layer 2′ is arranged with the second information layer depth 27′, and the optical record carrier 3″ includes a third transparent layer 5″ on one side of which the information layer 2″ is arranged with the third information layer depth 27″.

In this embodiment, the optical record carrier 3, 3′ and 3″ are, by way of example only, a “Blu-ray Disc”—format disc, a DVD—format disc and a CD-format disc, respectively. Thus, the wavelength λ₁ is comprised in the range between 365 and 445 nm, and preferably, is 405 nm. The numerical aperture NA₁ equals about 0.85 in both the reading mode and the writing mode. The wavelength λ₂ is comprised in the range between 620 and 700 nm, and preferably, is 650 nm. The numerical aperture NA₂ equals about 0.6 in the reading mode and is above 0.6, preferably 0.65, in the writing mode. The wavelength λ₃ is comprised in the range between 740 and 820 nm and, preferably is about 785 nm. The numerical aperture NA₃ is below 0.5, and is preferably 0.45 for the reading of information from CD-format discs, and preferably between 0.5 and 0.55 for writing information to CD-format discs.

1-19. (canceled)

20. A switchable optical element (100; 200; 30) having an optical axis (119), the element comprising a chamber (102);
a wave front modifier (107a-107d) having a face defining an interior surface of the chamber, the face extending transverse the optical axis;
a first fluid (120) and a second fluid (122), the fluids being immiscible and being in contact over an interface, the chamber enclosing both fluids (120, 122) in both discrete states and the interface extending transverse the optical axis (119) in the first discrete state;
the optical element being switchable between a first discrete state in which the first fluid (120) substantially covers the face of the wave front modifier (107a-107d), and a second discrete state in which the second fluid (122) substantially covers the face of the wave front modifier (107a-107d);
the optical element further comprising a fluid switching system (130, 132, 134; 134′) arranged to switch the optical element (100; 200; 30) between the first and second discrete states by moving the fluids utilising the electrowetting effect,
the fluid switching system comprising a first electrode (132) coupled to the second fluid (122), and a second electrode (134; 134′) located adjacent the face of the wave front modifier, characterised in that
the second electrode (134′) comprises a plurality of independently addressable sections.

21. An optical element as claimed in claim 20, wherein the face of the wave front modifier (107a-107d) comprises a first contact layer forming an insulating barrier (108) between the second electrode (134; 134′) and the fluids (120, 122) within the chamber.

22. An optical element as claimed in claim 20, wherein the second electrode (134; 134′) extends adjacent the face of the wave front modifier (107a-107d), a fixed predetermined distance from the face of the wave front modifier.

23. An optical element as claimed in claim 20, wherein the face of the wave front modifier is non-planar.

24. An optical element as claimed in claim 20, wherein the face of the wave front modifier defines at least one protrusion (107a-107d).

25. An optical element as claimed in claim 24, wherein said at least one protrusion (107a-107d) is less than 50 μm in height (h).

26. An optical element as claimed in claim 24, wherein said at least one protrusion (107a-107d) forms a diffraction grating.

27. An optical element as claimed in claim 20, wherein the chamber comprises at least one sidewall (110; 110′) to which the interface (124; 124′) extends in the first discrete state.

28. An optical element as claimed in claim 27, wherein the wettability of said sidewall (110) is such that the interface (124; 124′) extends in a plane transverse the optical axis when in the first discrete state.

29. An optical element as claimed in claim 27, wherein the wettability of said sidewall (110′) is such that the interface (124; 124′) is curved when in the first discrete state.

30. An optical element as claimed in any claim 27, further comprising an interface electrode (136) located adjacent said at least one sidewall (110′) for controlling the wettability of said wall (110′).

31. An apparatus (1) comprising a switchable optical element (100; 200; 30) as claimed in claim 20.

32. An apparatus as claimed in claim 31, wherein the apparatus is an optical scanning device (1).

33. A method of operating an apparatus (1) comprising:
a switchable optical element (100; 200; 30) having an optical axis (119), the element comprising a chamber (102);
a wave front modifier (107a-107d) having a face defining an interior surface of the chamber, the face extending transverse the optical axis;
a first fluid (120) and a second fluid (122), the fluids being immiscible and being in contact over an interface, the chamber enclosing both fluids (120, 122) in both discrete states and the interface extending transverse the optical axis (119) in the first discrete state;
the optical element being switchable between a first discrete state in which the first fluid (120) substantially covers the face of the wave front modifier (107a-107d), and a second discrete state in which the second fluid (122) substantially covers the face of the wave front modifier (107a-107d);
the optical element further comprising a fluid switching system (130, 132, 134; 134′) arranged to switch the optical element (100; 200; 30) between the first and second discrete states by moving the fluids utilising the electrowetting effect,
the fluid switching system comprising a first electrode (132) coupled to the second fluid (122), and a second electrode (134; 134′) located adjacent the face of the wave front modifier, wherein the second electrode (134′) comprises a plurality of independently addressable sections, the method comprising:
switching the optical element (3) between the first discrete state and the second discrete state.

34. A method as claimed in claim 33, wherein the apparatus further comprises a radiation source (7) arranged to provide a first beam of radiation in a first mode of operation, and a second beam of radiation in a second mode of operation,
the method comprising the further step of:
switching the optical element (30) between the discrete states in dependence upon a signal indicative of the mode of operation of the radiation source.

35. A method of manufacturing a switchable optical element having an optical axis, the method comprising:
providing a chamber (102);
providing a wave front modifier (107a-107d) having a face defining an interior surface of the chamber, the face extending transverse the optical axis;
providing a first fluid (120) and a second fluid (122), the fluids being immiscible and being in contact over an interface, the chamber enclosing both fluids (120, 122) in both discrete states and the interface extending transverse the optical axis (119) in the first discrete state;
providing a fluid switching system for switching the optical element between a first discrete state in which the first fluid (120) substantially covers the face of the wave front modifier (107a-107d), and a second discrete state in which the second fluid (122) substantially covers the face of the wave front modifier (107a-107d); the fluid switching system (130, 132, 134; 134′) arranged to switch the optical element (100; 200; 30) between the first and second discrete states by moving the fluids utilising the electrowetting effect; the fluid switching system comprising a first electrode (132) coupled to the second fluid (122), and a second electrode (134; 134′) located adjacent the face of the wave front modifier, and wherein the second electrode (134′) comprises a plurality of independently addressable sections.
